(19) United States
(12) Patent Application Publication
(10) Pub. No.: US 2011/0061240 A1
(43) Pub. Date: Mar. 17, 2011

(54) Utensil attachment to chopsticks

(76) Inventors: Randall Katsutoshi Kazama, Aiea, HI (US); Keith Yukio Yamasaki, Hilo, HI (US); Wallace Katsuichi Kazama, Aiea, HI (US)

(21) Appl. No.: 12/558,362

(22) Filed: Sep. 11, 2009

(51) Int. Cl. A47J 43/28

(52) U.S. Cl. 30/150

(57) ABSTRACT

A one-piece attachment; comprised of an upper section that is a hollow, tapered structure; top end having a slotted opening; made with the top end having the wider opening, tapering down to the bottom of this structure. The lower section is the fork/spoon head.

### FIELD OF THE INVENTION

The present invention relates generally to an eating utensil and more specifically it relates to an attachment to chopsticks. Simply connecting this attachment to a pair of chopsticks enables one to create a fork/spoon utensil. This invention can be more cost-effective and convenient for consumers and better for our environment.

### BACKGROUND OF THE INVENTION

Just about everyone uses disposable utensils. Disposable utensils are used for many occasions including parties and picnics, just to name a few. The largest amount of disposable utensils is used by the food service industry, primarily for “take-out” meals. With Asian Foods becoming more and more popular, many people have learned to use chopsticks though many still have not. The present invention can help those who rather eat with a fork and/or spoon rather than eat with chopsticks.

At most establishments, to help keep costs down, one is given a pair of chopsticks, a fork, or a spoon. Other establishments may include all three. The consumer will likely use only one of these utensils or chopsticks and the remaining will go unused and wasted into the trash. These materials will eventually find its way into our landfills. Unfortunately, the vast majority of disposable utensils are made out of plastics, which is very harmful to our environment. The present invention can reduce the amount of plastics used to make disposable utensils.

The attachment to chopsticks will be very helpful for “take-out” food establishments, consumers, and the environment. The present invention can be packaged together with a pair of chopsticks. This would allow the consumer to eat with the pair of chopsticks or use the Utensil Attachment to Chopstick and create a fork/spoon utensil to eat with. This would save time and money for food establishments and at the same time give the consumer a choice of utensil.

### SUMMARY OF THE INVENTION

The object of the present invention is to provide an attachment to chopsticks that allows one to simply convert a pair of chopsticks into a fork/spoon utensil. By connecting this attachment to a pair of chopsticks, the newly created utensil can now be used as a fork or a spoon. The pair of chopsticks will serve as a handle for the created fork/spoon utensil. The amount of plastic material needed to achieve the present invention will be less than the amount of plastic material needed to make just a single fork or spoon.

The Utensil Attachment to Chopsticks is a one piece item. For descriptive purposes only, I have separated the Utensil Attachment to Chopsticks into two structures: Structure A (top half) and Structure B (bottom half). I have also described each structure as having a top end and bottom end.

Structure (A) is a hollow, tapered structure with the top end having a slotted opening. Structure (A) is made with the top end having the wider opening, tapering down to the bottom of the structure. The front and back of Structure (A) are wider as compared to its sides. The function of the Structure (A) is to provide the connecting point with a pair of chopsticks. When connected with a pair of chopsticks, a snug-tight fit (friction) will hold the two items together. This connection with a pair of chopsticks will get tighter as the chopsticks are further advanced into Structure (A). The bottom end of this structure merges with the fork/spoon head (Structure B).

The Structure (B) is a fork/spoon head. The function of Structure (B) will be to make contact with food. Structure (B) will have two uses. It can be used as a fork or as a spoon.

A better understanding of how the present invention works along with its advantages will be more readily understood with the following detailed description and drawings.

### BRIEF DESCRIPTION OF DRAWINGS

FIG. 1: FIG. 1 is a front view of the present invention.

FIG. 2: FIG. 2 is perspective view of the present invention.

FIG. 3: FIG. 3 is a side view of the present invention.

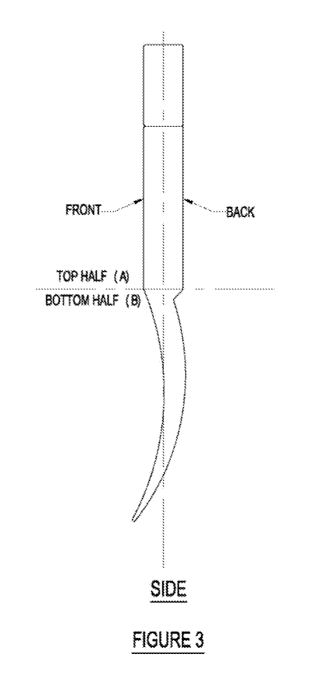

### DETAILED DESCRIPTION OF THE INVENTION

What will be described and illustrated herein is a preferred embodiment of the invention along with some of its variations. The terms, descriptions, and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

Turning now descriptively to the drawings, in which similar reference characters denote similar elements throughout the several views, the figures illustrate a hollow, tapered, slotted opening, and a fork/spoon utensil head. The Utensil Attachment to Chopsticks is a one piece item. For descriptive purposes only, I have separated it into two Structures, (A) top half and (B) bottom half. I have also described each structure as having a top end and bottom end within each structure.

### Structure (A) (Top Half)

Hollow and Tapered with a Slotted Opening

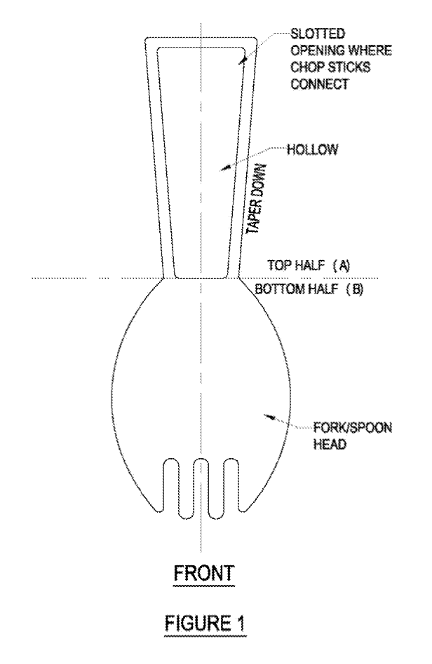

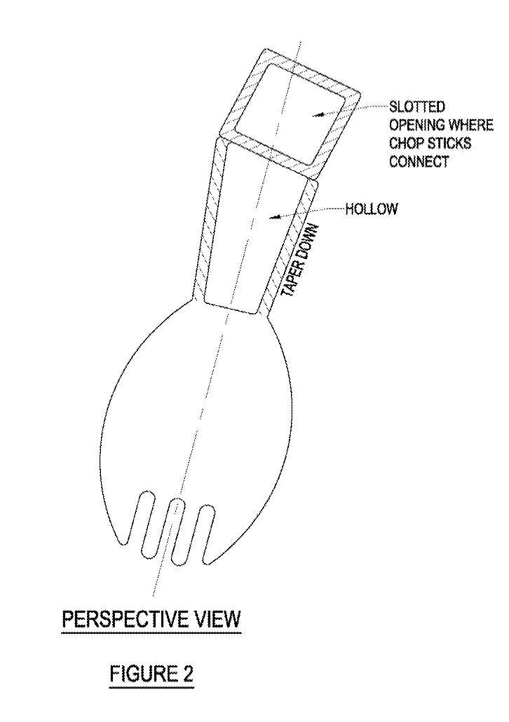

Referring to FIGS. 1 and 2. Structure (A) is a hollow and tapered item with the top end of the Structure (A) having a slotted opening. Structure (A) is made with the top end having the widest opening, tapering down to the bottom of the structure. The front and back of this structure are wider as compared to its sides. The function of Structure (A) is to provide the connecting point with a pair of chopsticks. A pair of chopsticks would be inserted into the top end of Structure (A), the slotted opening, to make the eating utensil complete. When connected with a pair of chopsticks, a snug-tight fit (friction) will hold the two items together. This connection with a pair of chopsticks will get tighter as the chopsticks are further advanced into Structure (A). The pair of chopsticks will then serve as the handle for the created fork/spoon utensil. Structure (A) is made to fit just about any type of chopsticks.

### Structure (B) (Bottom Half)

### Fork/Spoon Utensil Head

Structure (B) is made in the shape of a fork/spoon head. The function of Structure (B) will be to contact and pick-up the food. The fork/spoon head may be used as either a fork or a spoon.

What is claimed is:

1. A one piece attachment to chopsticks comprising of a hollow and tapered top half; the top half having a slotted opening and a bottom half comprising of a fork/spoon head.
Top Half:
Made up of a hollow, tapered structure with the top end having a slotted opening;
made with the top end having the wider opening, tapering down; the front and back are wider as compared to its sides; to provide the connecting point with a pair of chopsticks.
Bottom Half:
A fork/spoon shaped head; makes contact with and picks-up the food.
